(19) United States
(12) Patent Application Publication
(10) Pub. No.: US 2008/0295939 A1
(43) Pub. Date: Dec. 4, 2008

(54) METHOD FOR PREVENTING SLIPPAGE OF A TIRE ON A TIRE AND WHEEL ASSEMBLY, AND TIRE AND WHEEL ASSEMBLY OBTAINED THEREBY

(75) Inventor: Andre Peyrot, Clermont-Ferrand (FR)

Correspondence Address: BUCHANAN, INGERSOLL & ROONEY PC, POST OFFICE BOX 1404, ALEXANDRIA, VA, 22313-1404, US

(73) Assignees: MICHELIN RECHERCHE ET TECHNIQUE S.A., Granges-Paccot (CH); THE GOODYEAR TIRE & RUBBER COMPANY, Akron, OH (US)

(21) Appl. No.: 12/131,510

(22) Filed: Jun. 2, 2008

(30) Foreign Application Priority Data
Jun. 1, 2007 (EP) 07290687.8

(51) Int. Cl. B60C 5/16

(52) U.S. Cl. 152/375

(57) ABSTRACT

The present invention relates to a method for preventing rotatory slippage between a tire and wheel assembly, wherein said method comprises:
determining a zone of a bead surface having a substantially non-evolutionary surface contact pressure between a bead surface and a rim surface;
increasing said surface contact pressure between said bead surface and said rim surface in said determined zone.

The invention also includes tires and tire and wheel assemblies that are obtained by the method.

### BACKGROUND AND SUMMARY OF THE INVENTION

The present invention relates to the general field of tires and wheel assemblies comprising tires mounted thereon. Such tires are known per se, and generally comprise a crown section with two side walls. The tires are fitted with at least one bead, and usually two beads, which are located one at each end of a respective side wall. The beads are often rigid or semi-rigid, and may comprise one or more reinforcing elements, for example a rod, or bundle of cable or assembly of wires formed into a mesh or a rod shape, in order to confer a radial reinforcement to the bead of the tire. The tires are generally fitted to a wheel assembly via a rim present in the wheel assembly. In traditional tires, the wheel rim has a bearing or seating surface for a corresponding bead that slopes inwardly towards the centre of the wheel assembly. The bead of the tire is therefore defined in such a way as to have a heel part that abuts an inner, inwardly sloping seating surface of the rim and a toe part that abuts an outer, inwardly sloping surface of the rim. The outer, inwardly sloping surface of the rim describes a circle of greater diameter than the inner, inwardly sloping surface of the rim. When the tire is inflated, the pressure therein causes the beads to seat against the rim and securely hold the tire onto the rim.

In recent years, developments in tire manufacture have introduced a new tire and wheel assembly that is different from traditional assemblies in that the heel and toe of the bead have bearing surfaces that slope away from the axial centre of the tire. Corresponding rims have been developed that mate with the heel and toe surfaces of the tire bead. These tire and wheel systems therefore have a bearing surface, whether it be on the rim, the tire, or correspondingly on both, that slopes away from the axial centre of the tire and wheel assembly, towards the outside of said tire and assembly, providing an inner, outwardly sloping, heel bearing surface that describes a circle of greater diameter than the outer, outwardly sloping toe surface. An example is described in U.S. Pat. No. 6,581,846, in particular FIG. 1. In this new tire and wheel assembly the points of the bearing surface axially on the outside are on a circle the diameter of which being less than the diameter of the circle on which are the points of the same bearing surface axially to the inside (for convenience it is said that bearing surface is inclined towards the exterior, meaning towards the exterior of the tire cavity where acts the internal inflation pressure).

Under certain circumstances, particularly under high applied torque the tire of this last new tire and wheel assembly may slip relative to the rim. When slippage occurs, it can lead to undesirable effects such as loss of wheel balance, in turn leading to generation of vibrations; or excessive demands on the valve installation.

Slippage occurs when the ratio T/N, or tangential effort (T) over perpendicular effort (N), between the tire and rim, reaches what is known as the “slippage limit”. Attempts to avoid slippage have already been made by modifying the slippage limit, in particular by modifying the surface of the rim seats.

The present application proposes to improve the slippage in the tire and wheel assemblies having at least one of their bearing surfaces inclined towards the exterior. Accordingly one object of the present invention is a method for preventing rotatory slippage between a tire and wheel assembly, wherein said method comprises
determining a zone of a bead surface inclined towards the exterior and having a substantially non-evolutionary surface contact pressure between a bead surface and a rim surface; and
increasing said surface contact pressure between said bead surface and said rim surface in said determined zone.

The solution proposed above limits the ratio of T/N, thereby avoiding the requirement of modifying or reducing the slippage limit.

The expression “contact surface pressure” when used herein and in the claims means the pressure measured or calculated at the contact surface of the tire, in this case the bead of the tire, with the rim or vice-versa.

Generally, and preferably, when located on the bead or rim surfaces, the material of the surface contact pressure increase means is the same as the rim or bead surfaces, and in such a case, it is particularly advantageous to make the means an integral part of said surfaces, for example, by providing an extra thickness of said material in said zone, for example of elastomeric material, for example tire rubber, for the bead surface, and of metallic material, for example alloy, for the rim surface. In this way, it is possible to integrate the surface contact pressure increase means without having to be concerned about fixing the former to the rim or bead surfaces. However, as mentioned above, it is also possible to provide for separate surface contact pressure means, for example, in the shape of a rod, fibres, or layer of material, that may be elastomeric or metallic, or any other suitable material leading to the same end effect, i.e. an increase in the surface contact pressure in the zone.

The invention further comprises a tire and wheel assembly, wherein the tire has a bead surface that bears on a rim surface, and the bead surface is modified by surface contact pressure increase means located in a non-evolutionary surface contact pressure zone. In accordance with this object, said non-evolutionary surface contact pressure zone can be determined by measurement or calculation, for example, using the methods outlined above.

A further aspect of the invention is a tire, comprising surface contact pressure increase means located in a non-evolutionary surface contact pressure zone of a bead surface. Preferably, the surface contact pressure increase means are situated perpendicular to an axis of a reinforcement element, and tangential to an outward-most circumference of said reinforcement element, and extend outwards towards a toe region of a bead.

It is yet another aspect of the invention to provide a wheel assembly comprising a rim surface for receiving a bead from a tire having a tire bead surface, wherein the rim surface is modified in a zone corresponding to a non-evolutionary surface contact pressure zone of a tire bead surface. Even more preferably, the modified rim surface comprises surface contact pressure increase means that are integral with the rim surface.

The above and other aspects of the invention are further described in the accompanying figures and detailed examples, given merely for the purposes of illustration of the invention.

### BRIEF DESCRIPTION OF THE FIGURES

FIG. 1 schematically represents a cross-section of part of a prior art tire and wheel system, showing in particular a bead area of the tire and part of a wheel rim;

FIG. 2 schematically represents a cross-section of part of a tire system according to the present invention, in which the outer profile of the bead seat has been modified in accordance with the method of the invention;

FIGS. 3a and 3b represents a comparison of the contact surface pressures between the reference tire and wheel system (FIG. 3a) and those obtained in the tire and wheel system according to the present invention (FIG. 3b);

FIG. 4 represents a schematic close-up of the bead profile, and in particular that part of the bead profile that has been modified in accordance with the present invention.

### DETAILED DESCRIPTION OF PREFERRED EMBODIMENTS

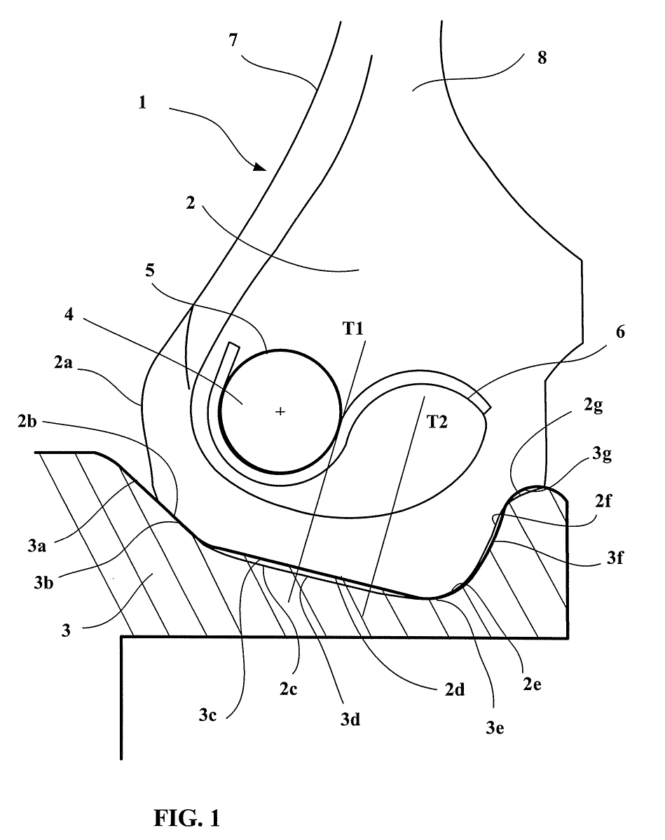

A reference tire and rim system or assembly is illustrated in cross-section in FIG. 1. Such a tire system is available under the reference nomenclature 245-690 R 500A and has a wheel dimension of substantially 235 millimetres by 500 millimetres. The representation is similar in substance to FIG. 1 of U.S. Pat. No. 6,571,846, except that the current figure is substantially a mirror image thereof, i.e. represents the opposite side of the same tire and wheel assembly. The system is represented by the general reference numeral 1. A bead 2 defining a bead surface 2a, 2b, 2c, 2d, 2e, 2f, 2g, and a rim 3 and corresponding rim surface 3a, 3b, 3c, 3d, 3e, 3f, 3g substantially contact one another. When viewed along the axis of rotation of the wheel and tire assembly, bead and rim surfaces 2b, 3b, wherein 2b represents the heel of the bead, have a greater diameter than bead and rim surfaces 2e, 3e, wherein 2e represents the toe of the bead. An outward slope, i.e. a slope that leans away from and to the exterior of the tire and wheel assembly, is thus formed between 2b, 3b and 2e, 3e. The bead 2 at 2f also abuts an upward rim projection known as a hump at 3f, and extends to also contact an upper zone 3g of the hump 3 at 2g. The slope or profile of the bead and rim between surfaces 2c, 3c and 2f, 3f is substantially constant, whereas the slope or profile of the bead and rim between surfaces 2b, 3b and 2c, 3c is preferably greater than the latter slope.

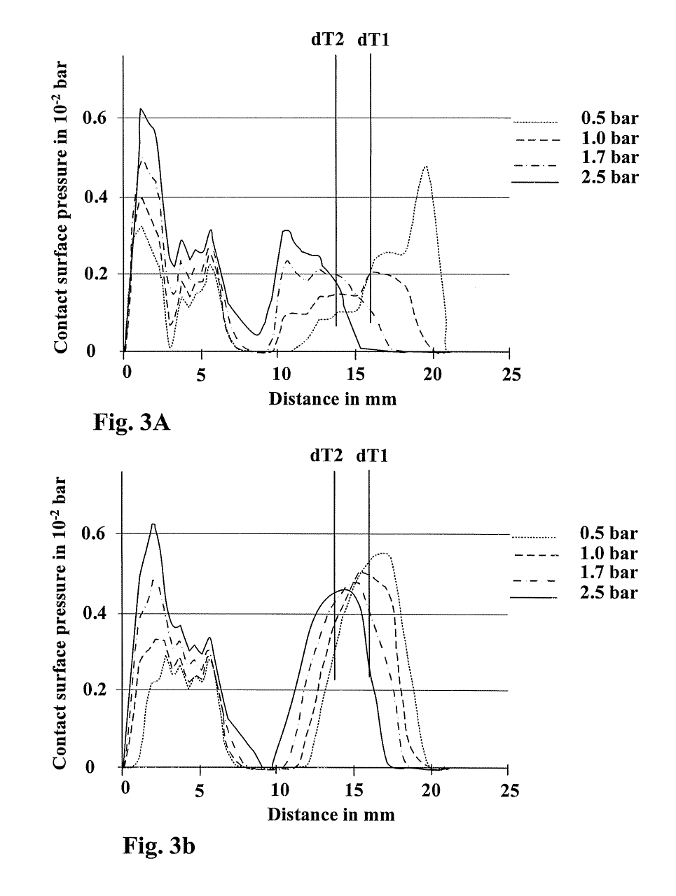

The bead of the tire also comprises one or more reinforcement elements 4, which can be rods, wires or cables, bundled or not bundled, as are well known to those skilled in the art of tire manufacture. The one or more reinforcement elements 4 define an outermost circumference 5, about which is wound a tire body reinforcement element 6 that extends upward to reinforce the side walls 7 of the tire body 8. An orthogonal or perpendicular imaginary line T1 can be drawn from said outermost circumference 5 that is tangential to the latter. The line T1 intersects the bead 2 and rim 3 surfaces at a right angle between 2c, 3c and 2d, 3d effectively delimiting these surfaces. A second imaginary line T2 can be drawn parallel to T1, which is also perpendicular to bead and rim surfaces 2 and 3, and forms the delimitation between surfaces 2d, 3d and 2e, 3e. It has been determined by calculation and experimentally that the surfaces 2d, 3d are the zones in which an increase in tire inflation pressure or mechanical forces leads to contact surface pressures between bead and rim which are substantially non-evolutionary, i.e. an increase in the tire inflation pressure or mechanical forces affecting the tire bead does not lead to any significant increased surface contact pressure, i.e. within the accuracy and statistical precision of measurement or calculation of the system under study. Such a zone can be seen in FIG. 3a, between the reference lines dT2 and dT1. It is believed by the present applicants that such a zone has never before been identified and represents a significant advance in the study of tire and wheel system behaviour. The origin of the abscissae of the curves shown on the graph is taken at the first point of contact of the bead with the rim on the rim's outer edge.

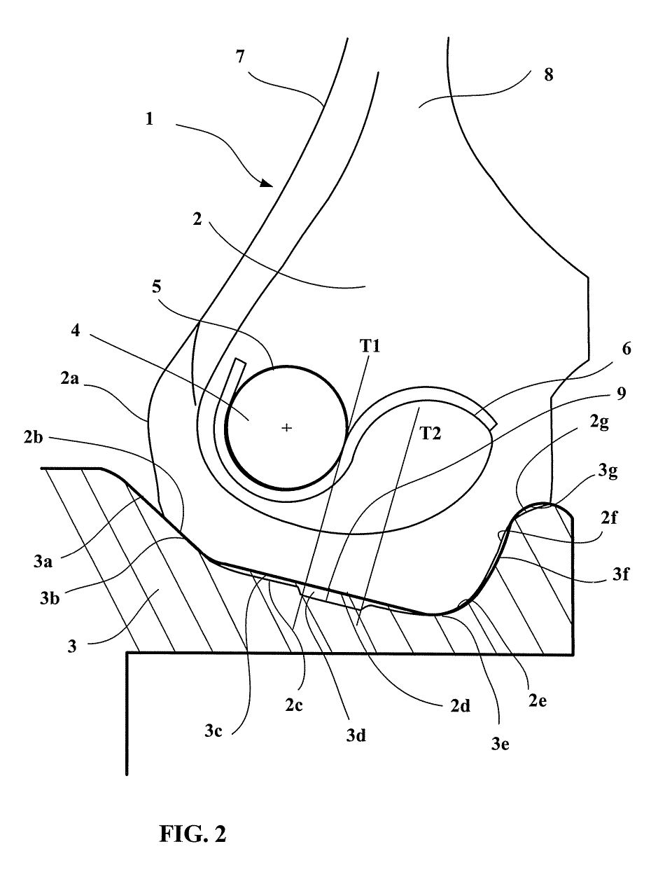

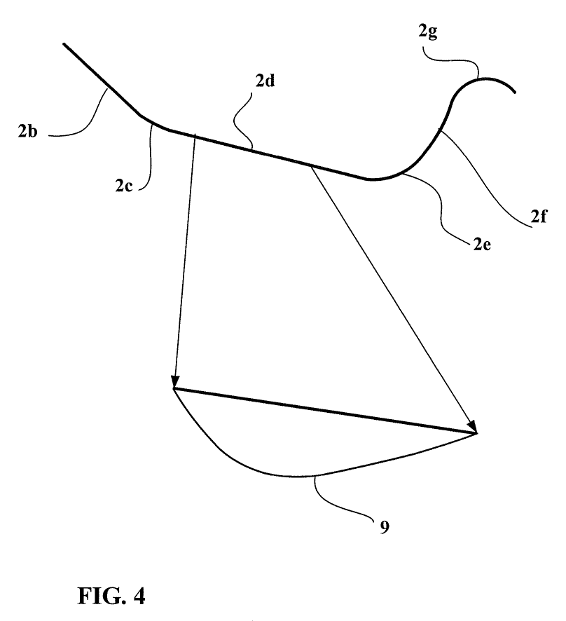

Turning now to FIG. 2, and a preferred embodiment of the present 15 invention, substantially the same illustration as FIG. 1 is shown, and like numerals indicate identical parts, elements and zones, except as otherwise indicated hereafter. In this embodiment, FIG. 2 illustrates a modified profile 9 in contact with the rim 3 and corresponding slopes of the bead 2 at the surface 2d. This modified profile 9 is preferably curved, and even more preferably generally convex, as shown in the close-up illustration of FIG. 4. The added material of the modified profile 9 is preferably formed from the same material as the bead itself, although it is perfectly possible to have integrated added material forming the curved profile that is different to that of the bead, depending on any particular desired rheological or mechanical characteristics that may be required or deemed advantageous. Additionally, the extra material comprising the curved profile 9 can be obtained by providing an insert at 2d of the bead, that is located between zones 2d and 3d, and provides sufficient friction between each of said zones. In still yet another alternative, it is possible to provide the. rim with a modified profile, in a similar or corresponding or mating manner to the bead profile.

FIG. 3b illustrates the change in contact surface pressure of the tire and rim assembly according to the present invention, and the preferred embodiment described above and illustrated in FIGS. 2 and 4. From this FIG. 3b, and under the same conditions as in FIG. 3a, it is clear that contact surface pressures are significantly increased in the non-evolutionary zone 2d, delimited by dT2 and dT1, and comprising the modified profile. The applicants have therefore successfully demonstrated and validated their hitherto unknown discovery of the non-evolutionary zone 2d, which in turn reduces the occurrence of slippage in a surprising manner. Moreover, it has been demonstrated as shown in FIG. 3b and FIG. 4 that the surface contact pressure can be substantially doubled when the profile 9 is modified by providing approximately on average 0.4 millimetres thickness of extra matter to the bead surface 2d.

1. A method for preventing rotatory slippage between a tire and wheel assembly, said tire having bearing surfaces, at least one of these bearing surfaces being inclined towards the exterior, wherein said method comprises:
determining a zone of a bead surface inclined towards the exterior and having a substantially non-evolutionary surface contact pressure between a bead surface and a rim surface; and
increasing said surface contact pressure between said bead surface and said rim surface in said determined zone.

2. The method according to claim 1, wherein the determination step is carried out under increasing tire inflation pressure.

3. The method according to claim 1, wherein the zone is determined by measurement.

4. The method according to claim 1, wherein the zone is determined by calculation.

5. The method according to claim 1, wherein the surface contact pressure in said determined zone is increased by locating surface contact pressure increase means in said determined zone.

6. The method according to claim 5, wherein the surface contact pressure increase means are located in said zone on the rim surface.

7. The method according to claim 5, wherein the surface contact pressure increase means are located in said zone on the bead surface.

8. The method according to claim 5, wherein the surface contact pressure increase means are located in said zone between said bead surface and said rim surface.

9. The method according to claim 1, wherein the surface contact pressure between said bead surface and said rim surface is increased by providing an extra thickness of bead material in said determined zone.

10. The method according to claim 1, wherein the surface contact pressure between said bead surface and said rim surface is increased by providing an extra thickness of rim material in said determined zone.

11. The method according to claim 1, wherein the surface contact pressure between said bead surface and said rim surface is increased by providing a separate layer of material between said bead surface and said rim surface.

12. The method according to claim 1, wherein said determined zone is situated axially outside and away from a reinforcement, and extends outwards towards a toe region of a bead.

13. The method according to claim 1, wherein said determined zone is situated perpendicular to an axis of a reinforcement element, and tangential to an outward-most circumference of said reinforcement element, and extends outwards towards a toe region of a bead.

14. A tire and wheel assembly having bearing surfaces, at least one of these bearing surfaces being inclined towards the exterior, wherein the tire has a bead surface that bears on a rim surface, and the bead surface is modified by surface contact pressure increase means located in a non-evolutionary surface contact pressure zone.

15. The tire and wheel assembly according to claim 14, wherein said non-evolutionary surface contact pressure zone is determined by measurement or calculation.

16. The tire and wheel assembly according to claim 14, wherein said non-evolutionary surface contact pressure zone is situated axially outside and away from a reinforcement element, and extends outwards towards a toe region of a bead.

17. The tire and wheel assembly according to claim 14, wherein said non-evolutionary surface contact pressure zone is situated perpendicular to an axis of a reinforcement element, and tangential to an outward-most circumference of said reinforcement element, and extends outwards towards a toe region of a bead.

18. The tire and wheel assembly according to claim 14, further comprising surface contact pressure increase means which have a substantially curved profile.

19. The tire and wheel assembly according to claim 18, wherein said surface contact pressure increase means are an integral part of the bead.

20. A tire, comprising surface contact pressure increase means located in a non-evolutionary surface contact pressure zone of a bead surface.

21. The tire according to claim 20, wherein the surface contact pressure increase means are situated perpendicular to an axis of a reinforcement element, and tangential to an outward-most circumference of said reinforcement element, and extend outwards towards a toe region of a bead.

22. The tire according to claim 20, wherein the surface contact pressure increase means are situated axially outside and away from a reinforcement element, and extend outwards towards a toe region of a bead.

23. The tire according to claim 20, wherein the surface contact pressure increase means have a substantially curved profile.

24. The tire according to claim 20, wherein the surface contact pressure increase means are an integral part of the bead.

25. A wheel assembly comprising a rim surface for receiving a bead from a tire having a tire bead surface, wherein the rim surface is modified in a zone corresponding to a non-evolutionary surface contact pressure zone of a tire bead surface.

26. The wheel assembly according to claim 25, wherein the modified rim surface comprises surface contact pressure increase means that are integral with the rim surface.
